(19) United States
(12) Patent Application Publication
(10) Pub. No.: US 2024/0176742 A1
(43) Pub. Date: May 30, 2024

(54) PROVIDING MEMORY REGION PREFETCHING IN PROCESSOR-BASED DEVICES

(71) Applicant: QUALCOMM Incorporated, San Diego, CA (US)

(72) Inventor: Suryanarayana Murthy Durbhakula, Hyderabad (IN)

(21) Appl. No.: 18/059,076

(22) Filed: Nov. 28, 2022

(51) Int. Cl. G06F 12/0862; G06F 12/0804; G06F 12/123

(52) U.S. Cl. CPC G06F 12/0862; G06F 12/0804; G06F 12/123; G06F 2212/1024; G06F 2212/602

(57) ABSTRACT

Providing memory region prefetching in processor-based devices is disclosed. In some aspects, a processor-based device comprises a region prefetcher circuit that comprises a plurality of access bitmaps corresponding to a plurality of contiguous memory regions of a system memory device. Each access bitmap comprises a plurality of bits corresponding to a plurality of memory blocks of a contiguous memory region. The region prefetcher circuit detects a memory access request to a memory block of a contiguous memory region, identifies an access bitmap corresponding to the contiguous memory region, and identifies a bit corresponding to the memory block. The region prefetcher circuit sets the bit to indicate the memory access request to the memory block. The region prefetcher circuit subsequently detects a prefetch trigger event, and, in response, identifies one or more unset bits of the access bitmap, and prefetches one or more memory blocks corresponding to the unset bits.

### BACKGROUND

### I. Field of the Disclosure

The technology of the disclosure relates generally to the use of prefetching in processor-based devices.

### II. Background

Processors, such as Graphics Processing Units (GPUs), are subject to a phenomenon known as memory access latency, which is a time interval between the time the processor initiates a memory access request (i.e., by executing a memory load instruction) for data and the time the processor actually receives the requested data. If the memory access latency for a memory access request is large enough, the processor may be forced to stall further execution of instructions while waiting for a memory access request to be fulfilled. Thus, a number of different approaches have been developed to reduce memory access latency in processor-based devices.

In the case of a GPU, a large proportion of graphics workloads tend to be memory-bound, such that GPU accesses to a system memory device (e.g., a Dynamic Random Access Memory (DRAM) device, as a non-limiting example) account for a large proportion of memory access latency encountered by the GPU. One approach to minimizing the effects of such memory access latency is the use of cache memory, also referred to simply as “cache” or “unified cache (UCHE).” A cache is a memory device that has a smaller capacity than system memory, but that can be accessed faster by a processor due to the type of memory used and/or the physical location of the cache relative to the processor. As a result, the cache can be used to store copies of data retrieved from frequently accessed memory locations in the system memory (or from a higher-level cache memory such as a Last Level Cache (LLC)) to reduce memory access latency.

However, a cache may not prove effective in addressing memory access latency issues in scenarios in which memory accesses do not conform to any fixed pattern (e.g., because the memory accesses do not exhibit high enough levels of spatial and/or temporal locality). Moreover, a miss on the cache may exacerbate memory access latency issues, because the time required to access the cache and determine that the requested data is not present will cause the processor to incur an even greater delay in obtaining the data.

### SUMMARY OF THE DISCLOSURE

Aspects disclosed in the detailed description include providing memory region prefetching in processor-based devices. Related apparatus and methods are also disclosed. In this regard, in some exemplary aspects disclosed herein, a processor-based device provides a region prefetcher circuit. Some aspects disclosed herein provide the region prefetcher circuit as part of a memory controller of a system memory device, while some aspects provide the region prefetcher circuit as part of a cache memory device. The region prefetcher circuit provides a plurality of access bitmaps, each corresponding to one of a plurality of contiguous memory regions (e.g., an open page or other predefined subset) of a system memory device. Each access bitmap comprises a plurality of bits that each corresponds to a memory block (e.g., having a size corresponding to a system cache line size of the processor) of the contiguous memory region associated with the access bitmap. The region prefetcher circuit is configured to detect a first memory access request to a first memory block of a first contiguous memory region of the system memory device. The region prefetcher circuit next identifies a first access bitmap that corresponds to the first contiguous memory region, and further identifies a first bit, within the first access bitmap, that corresponds to the first memory block. The region prefetcher circuit then sets the first bit to indicate the first memory access request to the first memory block. Upon detecting a subsequent prefetch trigger event, the region prefetcher identifies one or more unset bits of the first access bitmap, and then prefetches one or more memory blocks, corresponding to the one or more unset bits, of the first contiguous memory region. In aspects in which the region prefetcher circuit is part of the memory controller, the region prefetcher circuit may prefetch the one or more memory blocks from the system memory device into a prefetch buffer. In aspects in which the region prefetcher circuit is part of the cache memory device, the region prefetcher circuit may prefetch the one or more memory blocks from the system memory device or from a Last Level Cache (LLC) memory device into the cache memory device.

According to some aspects, prior to setting the first bit, the region prefetcher circuit may allocate the first access bitmap for the first contiguous memory region. Some such aspects may provide that allocating the first access bitmap comprises first determining that no access bitmap of the plurality of access bitmaps is available. The region prefetcher circuit then allocates an in-use access bitmap as the first access bitmap according to a Least-Recently-Used (LRU) replacement policy.

In some aspects (e.g., aspects in which the region prefetcher circuit is part of the memory controller), the region prefetcher circuit may detect the prefetch trigger event by determining that the first contiguous memory region (e.g., an open memory page) corresponding to the first access bitmap is to be closed. In some such aspects, the region prefetcher circuit may also clear the first access bitmap after the first contiguous memory region is closed. Some aspects may provide that the region prefetcher circuit may detect the prefetch trigger event by determining that a count of set bits of the plurality of bits of the first access bitmap exceeds a set bit threshold (e.g., one-fourth of the number of bits representing the first contiguous memory region).

Some aspects in which the region prefetcher circuit is part of the memory controller may further provide that the region prefetcher circuit may subsequently detect a second memory access request to a second memory block of the first contiguous memory region, identify the first access bitmap corresponding to the first contiguous memory region, and identify a second bit, corresponding to the second memory block, within the first access bitmap. If the second bit is set (indicating that the second memory block has been prefetched into the prefetch buffer), the region prefetcher circuit fulfills the second memory access request using data corresponding to the second memory block from the prefetch buffer. However, if the region prefetcher circuit determines that the second bit is not set, the region prefetcher circuit forwards the second memory access request to the memory controller.

In some aspects, the region prefetcher circuit may determine that a writeback results in a hit in the prefetch buffer. In response, the region prefetcher circuit may invalidate a prefetch buffer entry of the prefetch buffer corresponding to the writeback, and forward the writeback to the memory controller of the system memory device.

In another aspect, a processor-based device is provided. The processor-based device comprises a region prefetcher circuit that comprises a plurality of access bitmaps, each of which corresponds to a contiguous memory region of a plurality of contiguous memory regions of a system memory device. Each access bitmap comprises a plurality of bits, each of which corresponds to a memory block of a plurality of memory blocks of the contiguous memory region. The region prefetcher circuit is configured to detect a first memory access request to a first memory block of a first contiguous memory region of the plurality of contiguous memory regions. The region prefetcher circuit is further configured to identify a first access bitmap corresponding to the first contiguous memory region. The region prefetcher circuit is also configured to identify a first bit, corresponding to the first memory block, of the plurality of bits of the first access bitmap. The region prefetcher circuit is additionally configured to set the first bit to indicate the first memory access request to the first memory block. The region prefetcher circuit is further configured to detect a prefetch trigger event. The region prefetcher circuit is also configured to, responsive to detecting the prefetch trigger event, identify one or more unset bits of the first access bitmap, and prefetch one or more memory blocks, corresponding to the one or more unset bits, of the first contiguous memory region.

In another aspect, a processor-based device is provided. The processor-based device comprises means for detecting a first memory access request to a first memory block of a first contiguous memory region of a plurality of contiguous memory regions of a system memory device. The processor-based device further comprises means for identifying a first access bitmap, corresponding to the first contiguous memory region, of a plurality of access bitmaps, each corresponding to a contiguous memory region of the plurality of contiguous memory regions. The processor-based device also comprises means for identifying a first bit, corresponding to the first memory block, of a plurality of bits of the first access bitmap. The processor-based device additionally comprises means for setting the first bit to indicate the first memory access request to the first memory block. The processor-based device further comprises means for detecting a prefetch trigger event. The processor-based device also comprises means for, responsive to detecting the prefetch trigger event, identifying one or more unset bits of the first access bitmap, and prefetching one or more memory blocks, corresponding to the one or more unset bits, of the first contiguous memory region.

In another aspect, a method for providing memory region prefetching in processor-based devices is provided. The method comprises detecting, by a region prefetcher circuit of a processor-based device, a first memory access request to a first memory block of a first contiguous memory region of a plurality of contiguous memory regions of a system memory device. The method further comprises identifying, by the region prefetcher circuit, a first access bitmap, corresponding to the first contiguous memory region, of a plurality of access bitmaps, each corresponding to a contiguous memory region of the plurality of contiguous memory regions. The method also comprises identifying, by the region prefetcher circuit, a first bit, corresponding to the first memory block, of a plurality of bits of the first access bitmap. The method additionally comprises setting, by the region prefetcher circuit, the first bit to indicate the first memory access request to the first memory block. The method further comprises detecting, by the region prefetcher circuit, a prefetch trigger event. The method also comprises, responsive to detecting the prefetch trigger event, identifying, by the region prefetcher circuit, one or more unset bits of the first access bitmap, and prefetching, by the region prefetcher circuit, one or more memory blocks, corresponding to the one or more unset bits, of the first contiguous memory region.

### BRIEF DESCRIPTION OF THE FIGURES

FIG. 1 is a block diagram of an exemplary processor-based device including a region prefetcher circuit integrated into a memory controller for providing memory region prefetching, according to some aspects;

FIG. 2 is a block diagram of an exemplary processor-based device including a region prefetcher circuit integrated into a cache for providing memory region prefetching, according to some aspects;

FIGS. 3A-3D are flowcharts illustrating exemplary operations by the region prefetcher circuits of FIGS. 1 and 2 for providing memory region prefetching, according to some aspects; and

FIG. 4 is a block diagram of an exemplary processor-based device that can include the processor-based device of FIGS. 1 and 2.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include providing memory region prefetching in processor-based devices. Related apparatus and methods are also disclosed. In this regard, in some exemplary aspects disclosed herein, a processor-based device provides a region prefetcher circuit. Some aspects disclosed herein provide the region prefetcher circuit as part of a memory controller of a system memory device, while some aspects provide the region prefetcher circuit as part of a cache memory device. The region prefetcher circuit provides a plurality of access bitmaps, each corresponding to one of a plurality of contiguous memory regions (e.g., an open page or other predefined subset) of a system memory device. Each access bitmap comprises a plurality of bits that each corresponds to a memory block (e.g., having a size corresponding to a system cache line size of the processor) of the contiguous memory region associated with the access bitmap. The region prefetcher circuit is configured to detect a first memory access request to a first memory block of a first contiguous memory region of the system memory device. The region prefetcher circuit next identifies a first access bitmap that corresponds to the first contiguous memory region, and further identifies a first bit, within the first access bitmap, that corresponds to the first memory block. The region prefetcher circuit then sets the first bit to indicate the first memory access request to the first memory block. Upon detecting a subsequent prefetch trigger event, the region prefetcher identifies one or more unset bits of the first access bitmap, and then prefetches one or more memory blocks, corresponding to the one or more unset bits, of the first contiguous memory region. In aspects in which the region prefetcher circuit is part of the memory controller, the region prefetcher circuit may prefetch the one or more memory blocks from the system memory device into a prefetch buffer. In aspects in which the region prefetcher circuit is part of the cache memory device, the region prefetcher circuit may prefetch the one or more memory blocks from the system memory device or from a Last Level Cache (LLC) memory device into the cache memory device.

According to some aspects, prior to setting the first bit, the region prefetcher circuit may allocate the first access bitmap for the first contiguous memory region. Some such aspects may provide that allocating the first access bitmap comprises first determining that no access bitmap of the plurality of access bitmaps is available. The region prefetcher circuit then allocates an in-use access bitmap as the first access bitmap according to a Least-Recently-Used (LRU) replacement policy.

In some aspects (e.g., aspects in which the region prefetcher circuit is part of the memory controller), the region prefetcher circuit may detect the prefetch trigger event by determining that the first contiguous memory region (e.g., an open memory page) corresponding to the first access bitmap is to be closed. In some such aspects, the region prefetcher circuit may also clear the first access bitmap after the first contiguous memory region is closed. Some aspects may provide that the region prefetcher circuit may detect the prefetch trigger event by determining that a count of set bits of the plurality of bits of the first access bitmap exceeds a set bit threshold (e.g., one-fourth of the number of bits representing the first contiguous memory region).

Some aspects in which the region prefetcher circuit is part of the memory controller may further provide that the region prefetcher circuit may subsequently detect a second memory access request to a second memory block of the first contiguous memory region, identify the first access bitmap corresponding to the first contiguous memory region, and identify a second bit, corresponding to the second memory block, within the first access bitmap. If the second bit is set (indicating that the second memory block has been prefetched into the prefetch buffer), the region prefetcher circuit fulfills the second memory access request using data corresponding to the second memory block from the prefetch buffer. However, if the region prefetcher circuit determines that the second bit is not set, the region prefetcher circuit forwards the second memory access request to the memory controller.

In some aspects, the region prefetcher circuit may determine that a writeback results in a hit in the prefetch buffer. In response, the region prefetcher circuit may invalidate a prefetch buffer entry of the prefetch buffer corresponding to the writeback, and forward the writeback to the memory controller of the system memory device.

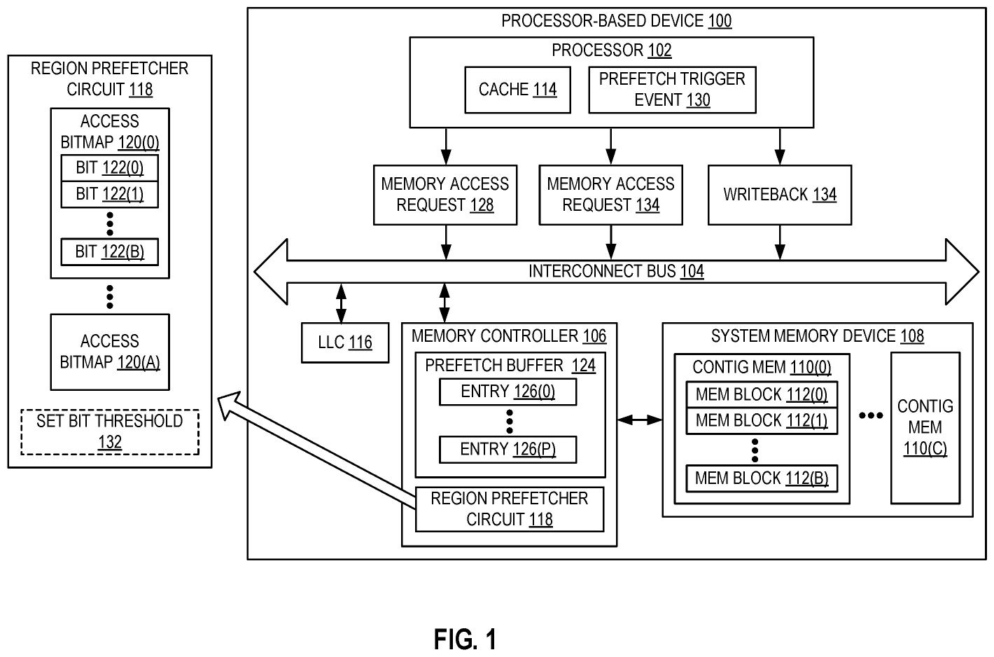

In this regard, FIG. 1 illustrates an exemplary processor-based device 100 that provides a processor 102 for providing memory region prefetching. The processor 102 in some aspects may comprise a central processing unit (CPU) or a graphics processing unit (GPU) having one or more processor cores, and in some exemplary aspects may be one of a plurality of similarly configured processors (not shown) of the processor-based device 100. The processor 102 is communicatively coupled to an interconnect bus 104, which in some embodiments may include additional constituent elements (e.g., a bus controller circuit and/or an arbitration circuit, as non-limiting examples) that are not shown in FIG. 1 for the sake of clarity.

The processor 102 is also communicatively coupled, via the interconnect bus 104, to a memory controller 106 that controls access to a system memory device 108 and manages the flow of data to and from the system memory device 108. The system memory device 108 provides addressable memory used for data storage by the processor-based device 100, and as such may comprise dynamic random access memory (DRAM), as a non-limiting example. As seen in FIG. 1, the system memory device 108 comprises a plurality of contiguous memory regions (captioned as “CONTIG MEM” in FIG. 1) 110(0)-110(C), each of which may correspond to, e.g., an open memory page or another predefined subset of the system memory device 108. Each of the contiguous memory regions 110(0)-110(C) comprises memory blocks such as the memory blocks (captioned as “MEM BLOCK” in FIG. 1) 112(0)-112(B) of the contiguous memory region 110(0). The memory blocks 112(0)-112(B) may each have a size that corresponds to a system cache line size of the processor 102. It is to be understood that, while not shown in FIG. 1, each of the contiguous memory regions 110(0)-110(C) comprises memory blocks similar to the memory blocks 112(0)-112(B) of the contiguous memory region 110(0).

The processor 102 of FIG. 1 further includes a cache memory device (captioned as “CACHE” in FIG. 1) 114 that may be used to cache local copies of frequently accessed data within the processor 102 for quicker access. The cache memory device 114 in some aspects may comprise, e.g., a Level 1 (L1) cache, or, in aspects in which the processor 102 comprises a GPU, a unified cache (UCHE). The cache memory device 114 provides a plurality of cache lines (not shown) for storing frequently accessed data retrieved from the system memory device 108. The cache lines comprise tags (not shown), each of which store information that enables the corresponding cache lines to be mapped to unique memory addresses, and further comprise data (not shown) in which the actual data retrieved from the system memory device 108 or from a higher-level cache is stored. It is to be understood that the cache lines of the cache memory device 114 may include other data elements, such as validity indicators and/or dirty data indicators, that are also not shown in FIG. 1 for the sake of clarity. The cache lines may be organized into one or more sets (not shown) that each comprise one or more ways (not shown), and the cache memory device 114 may be configured to support a corresponding level of associativity.

The processor 102 in the example of FIG. 1 is further communicatively coupled, via the interconnect bus 104, to a Last-Level Cache (LLC) memory device (captioned as “LLC” in FIG. 1) 116. The cache memory device 114 and the LLC memory device 116 together make up a hierarchical cache structure used by the processor-based device 100 to cache frequently accessed data for faster retrieval (compared to retrieving data from the system memory device 108).

The processor-based device 100 of FIG. 1 may encompass any one of known digital logic elements, semiconductor circuits, processing cores, and/or memory structures, among other elements, or combinations thereof. Embodiments described herein are not restricted to any particular arrangement of elements, and the disclosed techniques may be easily extended to various structures and layouts on semiconductor sockets or packages. It is to be understood that some embodiments of the processor-based device 100 may include more or fewer elements than illustrated in FIG. 1. For example, the processor 102 may further include more or fewer memory devices, execution pipeline stages, controller circuits, buffers, and/or caches, which are omitted from FIG. 1 for the sake of clarity.

As noted above, caches such as the cache memory device 114 and the LLC memory device 116 may be employed to minimize the effects of memory access latency encountered by the processor 102 when performing memory access operations on the system memory device 108. However, such caches may not prove effective in addressing memory access latency issues in scenarios in which memory accesses do not conform to any fixed pattern, such as circumstances in which the memory accesses do not exhibit high enough levels of spatial and/or temporal locality. Additionally, memory access latency issues may be exacerbated whenever a miss on the cache memory device 114 and/or the LLC memory device 116 occur.

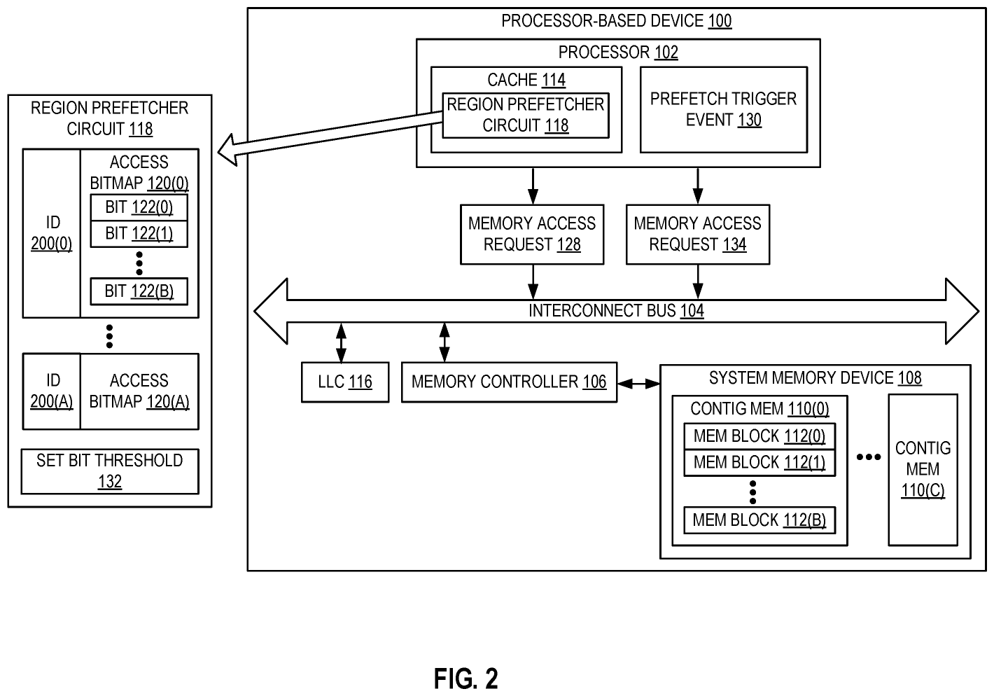

Accordingly, in this regard, the processor 102 provides a region prefetcher circuit 118 to perform memory region prefetching to reduce memory access latency for memory access requests to the system memory device 108. In the example illustrated in FIG. 1, the region prefetcher circuit 118 is provided as an element of the memory controller 106. An example of the processor-based device 100 in which the region prefetcher circuit 118 is provided as part of the cache memory device 114 is discussed in greater detail below with respect to FIG. 2.

As seen in FIG. 1, the region prefetcher circuit 118 provides a plurality of access bitmaps 120(0)-120(A), each of which corresponds to a contiguous memory region of the plurality of contiguous memory regions 110(0)-110(C) (e.g., the access bitmap 120(0) may correspond to the contiguous memory region 110(0), and so on in like fashion). Each of the access bitmaps 120(0)-120(A) comprises a plurality of bits, such as the bits 122(0)-122(B) of the access bitmap 120(0). Each bit of each of the access bitmaps 120(0)-120(A) corresponds to a memory block of the corresponding contiguous memory region 110(0)-110(C). Thus, for example, the bit 122(0) of the access bitmap 120(0) (which corresponds to the contiguous memory region 110(0)) corresponds to the memory block 112(0) of the contiguous memory region 110(0), while the bit 122(1) of the access bitmap 120(0) corresponds to the memory block 112(1) of the contiguous memory region 110(0), and so on in like fashion. It is to be understood that, while not shown in FIG. 1, each of the access bitmaps 120(0)-120(A) comprises bits similar to the bits 122(0)-122(B) of the access bitmap 120(0). In the example of FIG. 1, the number of access bitmaps 120(0)-120(A) is the same as the number of contiguous memory regions 110(0)-110(C) (e.g., open pages) in the system memory device 108.

In the example of FIG. 1, the memory controller 106 also includes a prefetch buffer 124 that comprises a plurality of prefetch buffer entries (captioned as “ENTRY” in FIG. 1) 126(0)-126(P). Although not shown in FIG. 1 for the sake of clarity, each of the prefetch buffer entries 126(0)-126(P) according to some aspects may comprise a cacheline aligned memory address corresponding to a memory block such as the memory blocks 112(0)-112(B), a copy of data stored in the corresponding memory block, and a valid indicator. The prefetch buffer 124 in some aspects may also store Least-Recently-Used (LRU) information (not shown) that may be used to track the least recently used prefetch buffer entries 126(0)-126(P).

In exemplary operation, the region prefetcher circuit 118 of FIG. 1 detects a memory access request 128 to, e.g., the memory block 112(0) of the contiguous memory region 110(0) of the system memory device 108. The region prefetcher circuit 118 identifies the access bitmap 120(0) as the access bitmap that corresponds to the contiguous memory region 110(0), and also identifies the bit 122(0) within the access bitmap 120(0) as the bit that corresponds to the memory block 112(0). The region prefetcher circuit 118 then sets the bit 122(0) (i.e., by changing its value to one (1)) to indicate the memory access request 128 to the memory block 112(0). Because memory blocks such as the memory block 112(0) generally are cached after being retrieved from the system memory device 108 in response to the memory access request 128, the bits 122(0)-122(B) serve to indicate which memory blocks among the memory blocks 112(0)-112(B) within the contiguous memory region 110(0) have been recently cached.

The region prefetcher circuit 118 subsequently detects a prefetch trigger event 130. In aspects in which the contiguous memory region 110(0) is an open page of the system memory device 108, the prefetch trigger event 130 may comprise the region prefetcher circuit 118 determining that the contiguous memory region 110(0) is to be closed. The prefetch trigger event 130 in some aspects may comprise the region prefetcher circuit 118 determining that a count of set bits (i.e., bits having a value of one (1)) among the bits 122(0)-122(B) of the access bitmap 120(0) exceeds a set bit threshold 132. For example, the set bit threshold 132 may be set to trigger the prefetch trigger event 130 when one-fourth of the number of bits 122(0)-122(B) have been set.

Upon detecting the prefetch trigger event 130, the region prefetcher circuit 118 identifies one or more unset bits (i.e., bits having a value of zero (0)) among the bits 122(0)-122(B) of the access bitmap 120(0). The region prefetcher circuit 118 then then prefetches one or more of the memory blocks 112(0)-112(B), corresponding to the one or more unset bits among the bits 122(0)-122(B), into the prefetch buffer 124. Thus, if the bit 122(1) in the example of FIG. 1 remains unset, the region prefetcher circuit 118 prefetches the corresponding memory block 112(1) into the prefetch buffer 124. In some aspects, the region prefetcher circuit 118 may also clear the access bitmap 120(0) (i.e., by setting the value of all of the bits 122(0)-122(B) to zero (0)) after the contiguous memory region 110(0) is closed.

Some aspects may further provide that the region prefetcher circuit 118 detects a subsequent memory access request 134 to a memory block, such as the memory block 112(0) of the contiguous memory region 110(0). The region prefetcher circuit 118 determines whether the memory access request 134 results in a hit on the prefetch buffer 124. If so, the region prefetcher circuit 118 fulfills the memory access request 134 using data corresponding to the memory block 112(0) from the prefetch buffer 124. However, if the region prefetcher circuit 118 determines that the memory access request 134 results in a miss on the prefetch buffer 124, the region prefetcher circuit 118 forwards the subsequent memory access request 134 to the memory controller 106 for handling in conventional fashion.

In some aspects, prior to setting the bit 122(0) in response to the memory access request 128, the region prefetcher circuit 118 may allocate the access bitmap 120(0) for the contiguous memory region 110(0) (e.g., if no access bitmap has been previously allocated). In aspects in which the number of access bitmaps 120(0)-120(A) is limited and no access bitmap is available, the region prefetcher circuit 118 may allocate an in-use access bitmap as the access bitmap 120(0) according to an LRU replacement policy.

According to some aspects, if data is updated in, e.g., the cache memory device 114, a writeback 136 of that data back to the system memory device 108 may be detected by the region prefetcher circuit 118. In response, the region prefetcher circuit 118 determines whether the writeback 136 results in a hit in the prefetch buffer 124. If so, the region prefetcher circuit 118 invalidates a prefetch buffer entry (e.g., the prefetch buffer entry 126(0)) of the prefetch buffer 124 corresponding to the writeback 136, and forwards the writeback 136 to the memory controller 106 of the system memory device 108 for processing in conventional fashion.

As noted above, the region prefetcher circuit 118 in some aspects may be implemented as part of the cache memory device 114 of the processor-based device 100. In this regard, FIG. 2 illustrates such an example. As seen in FIG. 2, the processor-based device 100 of FIG. 1 and its constituent elements are shown, with the exception of the prefetch buffer 124 which is not employed by the region prefetcher circuit 118 in FIG. 2. Additionally, because the cache memory device 114 does not have access to information regarding the number of contiguous memory regions 110(0)-110(C) of the system memory device 108 (e.g., the number of open memory pages), the number of access bitmaps 120(0)-120(A) will not correspond to the number of contiguous memory regions 110(0)-110(C). Consequently, the region prefetcher circuit 118 in the example of FIG. 2 further provides, for each access bitmap 120(0)-120(A), a memory region identifier (captioned as “ID” in FIG. 2) 200(0)-200(A) that identifies a memory region of the contiguous memory regions 110(0)-110(C) that corresponds to the access bitmap 120(0)-120(A). The memory region identifiers 200(0)-200(A), which may comprise tag information for each of the contiguous memory regions 110(0)-110(C), are set when the corresponding access bitmaps 120(0)-120(A) are allocated to the contiguous memory regions 110(0)-110(C). The region prefetcher circuit 118 of FIG. 2 may include additional elements not shown in FIG. 2 for the sake of clarity, such as valid indicators associated with each access bitmap 120(0)-120(A) and/or LRU data for the access bitmaps 120(0)-120(A).

The region prefetcher circuit 118 of FIG. 2 operates in substantially the same fashion as described above with respect to FIG. 1, with the differences noted below. In the example of FIG. 2, the prefetch trigger event 130 comprises the region prefetcher circuit 118 determining that the count of set bits (i.e., bits having a value of one (1)) among the bits 122(0)-122(B) of the access bitmap 120(0) exceeds the set bit threshold 132. The region prefetcher circuit 118 of FIG. 2 also performs the prefetch operation by prefetching one or more of the memory blocks 112(0)-112(B), corresponding to the one or more unset bits among the bits 122(0)-122(B), into the cache memory device 114 from the system memory device 108 or from the LLC memory device 116.

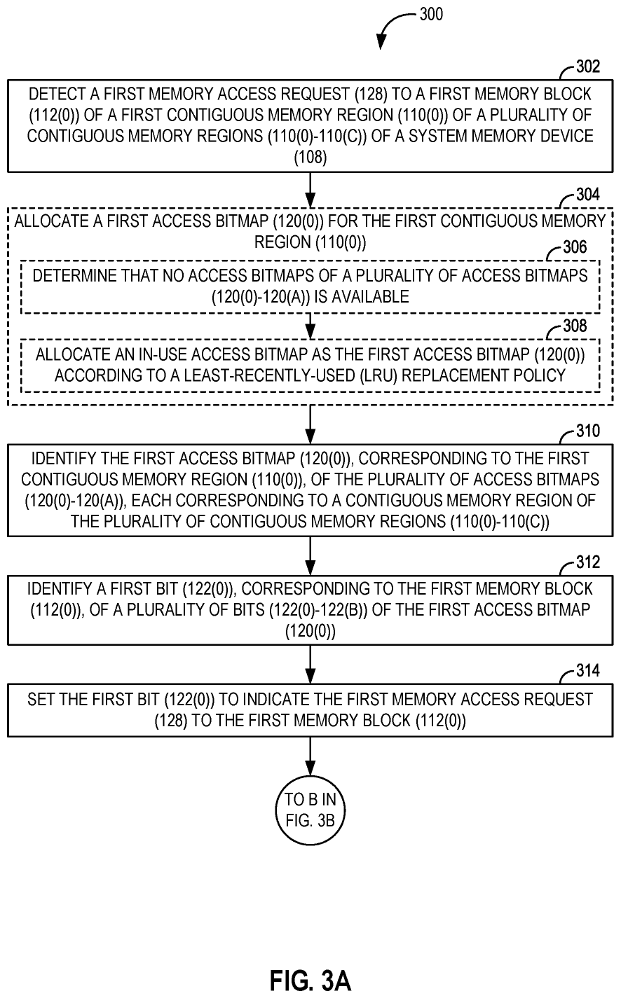

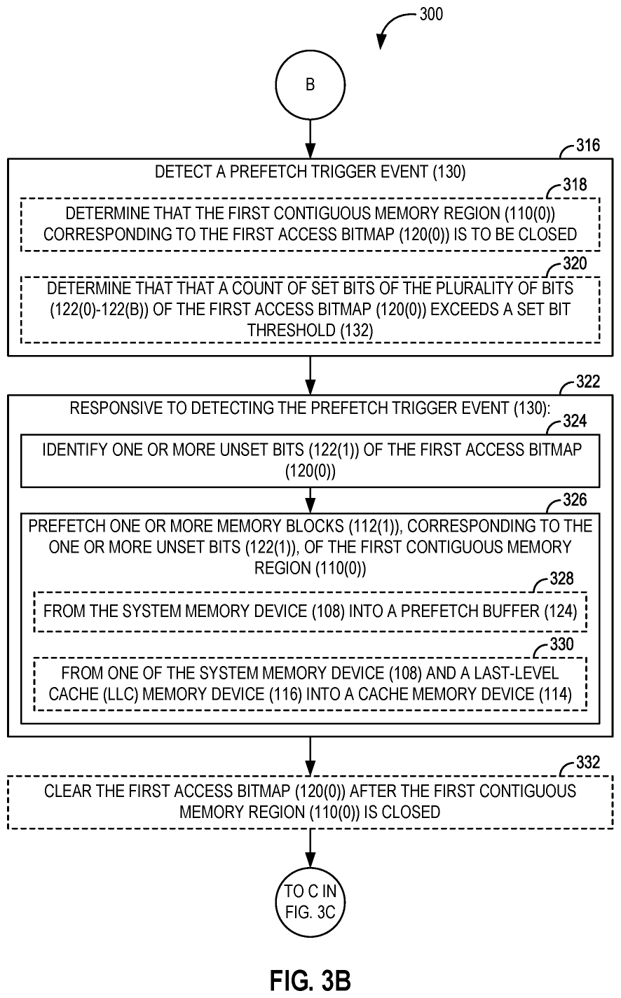

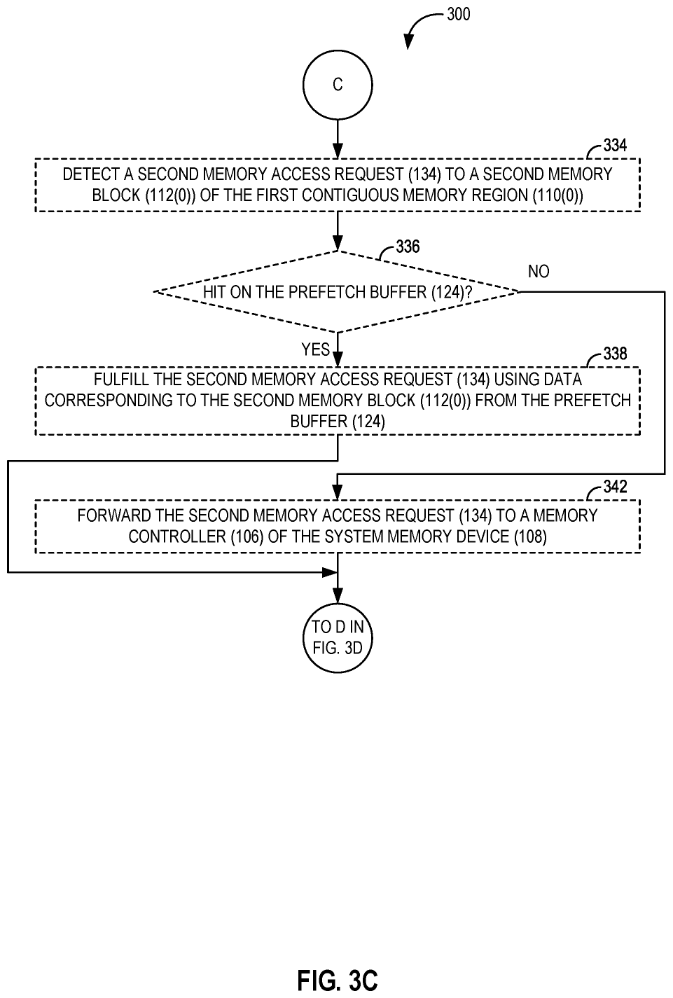

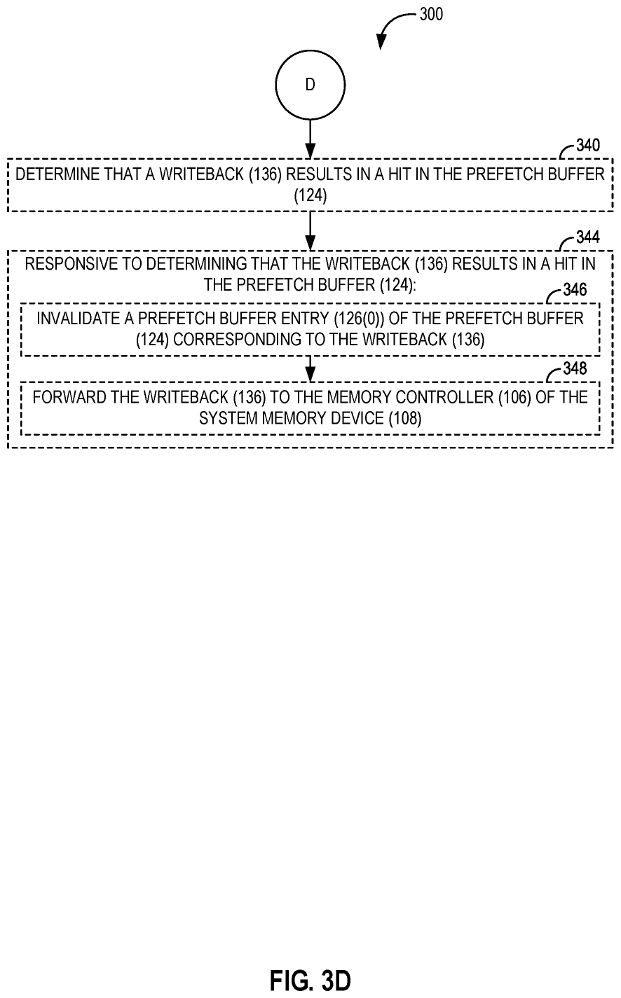

To further describe operations of the region prefetcher circuit 118 of FIGS. 1 and 2 for providing memory region prefetching, FIGS. 3A-3D provide a flowchart illustrating exemplary operations 300. For the sake of clarity, elements of FIGS. 1 and 2 are referenced in describing FIGS. 3A-3D. It is to be understood that some aspects may provide that some operations illustrated in FIGS. 3A-3D may be performed in an order other than that illustrated herein and/or may be omitted.

In FIG. 3A, the exemplary operations 300 begin with the processor 102 of FIG. 1 (e.g., using the region prefetcher circuit 118 of FIG. 1 and FIG. 2) detecting a first memory access request (e.g., the memory access request 128 of FIGS. 1 and 2) to a first memory block (e.g., the memory block 112(0) of FIGS. 1 and 2) of a first contiguous memory region of a plurality of contiguous memory regions (e.g., the contiguous memory region 110(0) of the plurality of contiguous memory regions 110(0)-110(C) of FIGS. 1 and 2) of a system memory device (e.g., the system memory device 108 of FIGS. 1 and 2) (block 302). In some aspects (e.g., the aspect illustrated in FIG. 2), the region prefetcher circuit 118 may allocate a first access bitmap (e.g., the access bitmap 120(0) of FIGS. 1 and 2) for the first contiguous memory region 110(0) (block 304). Some aspects may provide that the operations of block 304 for allocating the first access bitmap 120(0) may comprise first determining that no access bitmaps of a plurality of access bitmaps (e.g., the plurality of access bitmaps 120(0)-120(A) of FIG. 2) is available (block 306). The region prefetcher circuit 118 then allocates an in-use access bitmap as the first access bitmap 120(0) according to an LRU replacement policy (block 308).

The region prefetcher circuit 118 next identify the first access bitmap 120(0), corresponding to the first contiguous memory region 110(0), of the plurality of access bitmaps 120(0)-120(A), each corresponding to a contiguous memory region of the plurality of contiguous memory regions 110(0)-110(C) (block 310). The region prefetcher circuit 118 then identifies a first bit (e.g., the bit 122(0) of FIGS. 1 and 2), corresponding to the first memory block 112(0), of a plurality of bits (e.g., the plurality of bits 122(0)-122(B) of FIGS. 1 and 2) of the first access bitmap 120(0) (block 312). The region prefetcher circuit 118 sets the first bit 122(0) to indicate the first memory access request 128 to the first memory block 112(0) (block 314). The exemplary operations 300 then continue at block 316 of FIG. 3B.

Referring now to FIG. 3B, the exemplary operations 300 continue with the region prefetcher circuit 118 subsequently detecting a prefetch trigger event, such as the prefetch trigger event 130 of FIGS. 1 and 2 (block 316). According to some aspects, the operations of block 316 for detecting the prefetch trigger event 130 may comprise determining that the first contiguous memory region 110(0) corresponding to the first access bitmap 120(0) is to be closed (block 318). Some aspects may provide that the operations of block 316 for detecting the prefetch trigger event 130 may comprise determining that a count of set bits of the plurality of bits 122(0)-122(B) of the first access bitmap 120(0) exceeds a set bit threshold, such as the set bit threshold 132 of FIGS. 1 and 2 (block 320).

In response to detecting the prefetch trigger event 130, the region prefetcher circuit 118 performs a series of operations (block 322). The region prefetcher circuit 118 identifies one or more unset bits (e.g., the bit 122(1) of FIGS. 1 and 2) of the first access bitmap 120(0) (block 324). The region prefetcher circuit 118 then prefetches one or more memory blocks (e.g., the memory block 112(1) of FIGS. 1 and 2), corresponding to the one or more unset bits 122(1), of the first contiguous memory region 110(0) (block 326). In some aspects, the operations of block 326 for prefetching the one or more memory blocks 112(1) may comprise prefetching the one or more memory blocks 112(1) from the system memory device 108 into a prefetch buffer (e.g., the prefetch buffer 124 of FIG. 1) associated with the system memory device 108 (block 328). According to some aspects, the operations of block 326 for prefetching the one or more memory blocks 112(1) may comprise prefetching the one or more memory blocks 112(1) from one of the system memory device 108 and an LLC memory device (e.g., the LLC memory device 116 of FIGS. 1 and 2) into a cache memory device (e.g., the cache memory device 114 of FIGS. 1 and 2) (block 330). In aspects in which the prefetch trigger event 130 comprises determining that the first contiguous memory region 110(0) corresponding to the first access bitmap 120(0) is to be closed, the region prefetcher circuit 118 may also clear the first access bitmap 120(0) after the first contiguous memory region 110(0) is closed (block 332). The exemplary operations 300 in some aspects may continue at block 334 of FIG. 3C.

Turning now to FIG. 3C, the exemplary operations 300 in some aspects according to FIG. 1 may continue with the region prefetcher circuit 118 detecting a second memory access request (e.g., the memory access request 134 of FIGS. 1 and 2) to a second memory block (e.g., the memory block 112(0) of FIGS. 1 and 2) of the first contiguous memory region 110(0) (block 334). The region prefetcher circuit 118 then determines whether the second memory access request 134 results in a hit on the prefetch buffer 124 (block 336). If so, the region prefetcher circuit 118 fulfills the second memory access request 134 using data corresponding to the second memory block 112(0) from the prefetch buffer 124 (block 338). The exemplary operations 300 then continue at block 340 of FIG. 3D. However, if the region prefetcher circuit 118 determines at decision block 336 that the second memory access request 134 results in a miss on the prefetch buffer 124, the region prefetcher circuit 118 forwards the second memory access request 134 to a memory controller (e.g., the memory controller 106 of FIG. 1) of the system memory device 108 (block 342). The exemplary operations 300 according to some aspects may continue at block 340 of FIG. 3D.

With reference to FIG. 3D, the exemplary operations 300 in some aspects according to FIG. 1 may continue with the region prefetcher circuit 118 determining that a writeback (e.g., the writeback 136 of FIG. 1) results in a hit in the prefetch buffer 124 (block 340). In response to determining that the writeback 136 results in a hit in the prefetch buffer 124, the region prefetcher circuit 118 performs a series of operations (block 344). The region prefetcher circuit 118 invalidates a prefetch buffer entry (e.g., the prefetch buffer entry 126(0) of FIG. 1) of the prefetch buffer 124 corresponding to the writeback 136 (block 346). The region prefetcher circuit 118 then forwards the writeback 136 to the memory controller 106 of the system memory device 108 (block 348).

Providing memory region prefetching in processor-based devices as disclosed in aspects described herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

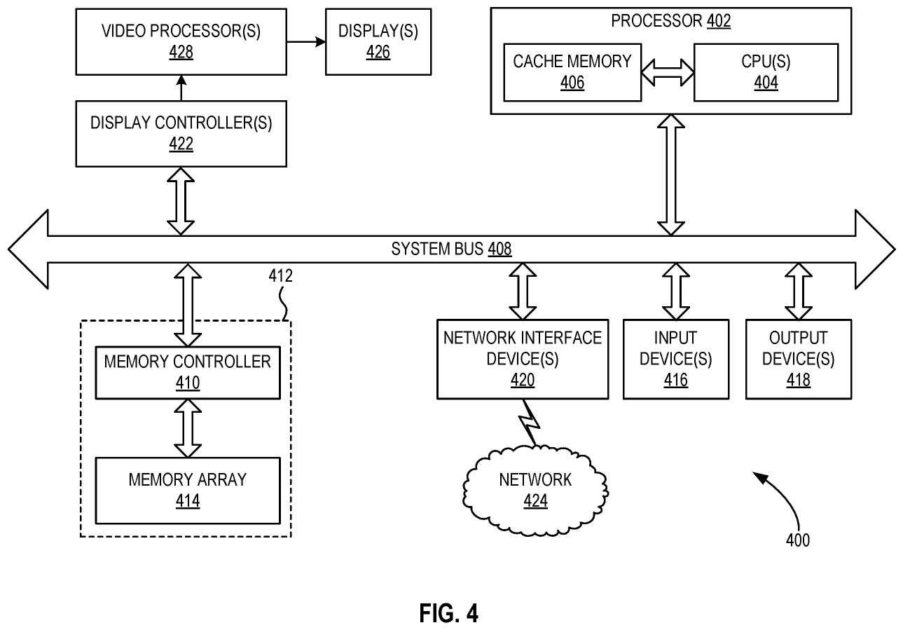

In this regard, FIG. 4 illustrates an example of a processor-based device 400 that may comprise the processor-based device 100 illustrated in FIGS. 1 and 2. In this example, the processor-based device 400 includes a processor 402 that includes one or more central processing units (captioned as “CPUs” in FIG. 4) 404, which may also be referred to as CPU cores or processor cores. The processor 402 may have cache memory 406 coupled to the processor 402 for rapid access to temporarily stored data. The processor 402 is coupled to a system bus 408 and can intercouple master and slave devices included in the processor-based device 400. As is well known, the processor 402 communicates with these other devices by exchanging address, control, and data information over the system bus 408. For example, the processor 402 can communicate bus transaction requests to a memory controller 410, as an example of a slave device. Although not illustrated in FIG. 4, multiple system buses 408 could be provided, wherein each system bus 408 constitutes a different fabric.

Other master and slave devices can be connected to the system bus 408. As illustrated in FIG. 4, these devices can include a memory system 412 that includes the memory controller 410 and a memory array(s) 414, one or more input devices 416, one or more output devices 418, one or more network interface devices 420, and one or more display controllers 422, as examples. The input device(s) 416 can include any type of input device, including but not limited to input keys, switches, voice processors, etc. The output device(s) 418 can include any type of output device, including, but not limited to, audio, video, other visual indicators, etc. The network interface device(s) 420 can be any device configured to allow exchange of data to and from a network 424. The network 424 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 420 can be configured to support any type of communications protocol desired.

The processor 402 may also be configured to access the display controller(s) 422 over the system bus 408 to control information sent to one or more displays 426. The display controller(s) 422 sends information to the display(s) 426 to be displayed via one or more video processors 428, which process the information to be displayed into a format suitable for the display(s) 426. The display controller(s) 422 and/or the video processors 428 may be comprise or be integrated into a GPU. The display(s) 426 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:

1. A processor-based device, comprising:
a region prefetcher circuit comprising a plurality of access bitmaps, each corresponding to a contiguous memory region of a plurality of contiguous memory regions of a system memory device;
   wherein each access bitmap comprises a plurality of bits, each corresponding to a memory block of a plurality of memory blocks of the contiguous memory region; and
the region prefetcher circuit configured to:
   detect a first memory access request to a first memory block of a first contiguous memory region of the plurality of contiguous memory regions;
   identify a first access bitmap corresponding to the first contiguous memory region;
   identify a first bit, corresponding to the first memory block, of the plurality of bits of the first access bitmap;
   set the first bit to indicate the first memory access request to the first memory block;
   detect a prefetch trigger event; and responsive to detecting the prefetch trigger event:
      identify one or more unset bits of the first access bitmap; and
      prefetch one or more memory blocks, corresponding to the one or more unset bits, of the first contiguous memory region.
         2. The processor-based device of clause 1, wherein:
each contiguous memory region of the plurality of contiguous memory regions comprises an open memory page of a plurality of open memory pages of the system memory device; and
the region prefetcher circuit is configured to prefetch the one or more memory blocks from the system memory device into a prefetch buffer.
   3. The processor-based device of clause 2, wherein:
the region prefetcher circuit is configured to detect the prefetch trigger event by being configured to determine that the first contiguous memory region corresponding to the first access bitmap is to be closed; and
the region prefetcher circuit is further configured to clear the first access bitmap after the first contiguous memory region is closed.
   4. The processor-based device of any one of clauses 2-3, wherein the region prefetcher circuit is configured to detect the prefetch trigger event by being configured to determine that a count of set bits of the plurality of bits of the first access bitmap exceeds a set bit threshold.
   5. The processor-based device of any one of clauses 2-4, wherein the region prefetcher circuit is further configured to:
detect a second memory access request to a second memory block of the first contiguous memory region;
determine whether the second memory access request results in a hit on the prefetch buffer;
responsive to determining that the second memory access request results in a hit on the prefetch buffer, fulfill the second memory access request using data corresponding to the second memory block from the prefetch buffer; and
responsive to determining that the second memory access request results in a miss on the prefetch buffer, forward the second memory access request to a memory controller of the system memory device.
   6. The processor-based device of any one of clauses 2-5, wherein the region prefetcher circuit is further configured to:
determine that a writeback results in a hit in the prefetch buffer; and responsive to determining that the writeback results in a hit in the prefetch buffer:
   invalidate a prefetch buffer entry of the prefetch buffer corresponding to the writeback; and
   forward the writeback to a memory controller of the system memory device.
      7. The processor-based device of any one of clauses 1-6, wherein:
the region prefetcher circuit is configured to prefetch the one or more memory blocks from one of the system memory device and a last-level cache (LLC) memory device into a cache memory device; and
the region prefetcher circuit is configured to detect the prefetch trigger event by being configured to determine that a count of set bits of the plurality of bits of the first access bitmap exceeds a set bit threshold.
   8. The processor-based device of any one of clauses 1-7, wherein the region prefetcher circuit is further configured to, prior to identifying a first access bitmap, allocate the first access bitmap for the first contiguous memory region.
   9. The processor-based device of clause 8, wherein the region prefetcher is configured to allocate the first access bitmap by being configured to:
determine that no access bitmap of the plurality of access bitmaps is available; and
allocate an in-use access bitmap as the first access bitmap according to a Least-Recently-Used (LRU) replacement policy.
   10. The processor-based device of any one of clauses 1-9, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.
   11. A processor-based device, comprising:
means for detecting a first memory access request to a first memory block of a first contiguous memory region of a plurality of contiguous memory regions of a system memory device;
means for identifying a first access bitmap, corresponding to the first contiguous memory region, of a plurality of access bitmaps, each corresponding to a contiguous memory region of the plurality of contiguous memory regions;
means for identifying a first bit, corresponding to the first memory block, of a plurality of bits of the first access bitmap;
means for setting the first bit to indicate the first memory access request to the first memory block;
means for detecting a prefetch trigger event; and
means for, responsive to detecting the prefetch trigger event:
   identifying one or more unset bits of the first access bitmap; and
   prefetching one or more memory blocks, corresponding to the one or more unset bits, of the first contiguous memory region.
      12. A method for performing memory region prefetching, comprising:
detecting, by a region prefetcher circuit of a processor-based device, a first memory access request to a first memory block of a first contiguous memory region of a plurality of contiguous memory regions of a system memory device;
identifying, by the region prefetcher circuit, a first access bitmap, corresponding to the first contiguous memory region, of a plurality of access bitmaps, each corresponding to a contiguous memory region of the plurality of contiguous memory regions;
identifying, by the region prefetcher circuit, a first bit, corresponding to the first memory block, of a plurality of bits of the first access bitmap;
setting, by the region prefetcher circuit, the first bit to indicate the first memory access request to the first memory block;
detecting, by the region prefetcher circuit, a prefetch trigger event; and responsive to detecting the prefetch trigger event:
   identifying, by the region prefetcher circuit, one or more unset bits of the first access bitmap; and
   prefetching, by the region prefetcher circuit, one or more memory blocks, corresponding to the one or more unset bits, of the first contiguous memory region.
      13. The method of clause 12, wherein:
each contiguous memory region of the plurality of contiguous memory regions comprises an open memory page of a plurality of open memory pages of the system memory device; and
the method comprises prefetching the one or more memory blocks from the system memory device into a prefetch buffer.
   14. The method of clause 13, wherein:
detecting the prefetch trigger event comprises determining that the first contiguous memory region corresponding to the first access bitmap is to be closed; and
the method further comprises clearing the first access bitmap after the first contiguous memory region is closed.
   15. The method of any one of clauses 13-14, wherein detecting the prefetch trigger event comprises determining that a count of set bits of the plurality of bits of the first access bitmap exceeds a set bit threshold.
   16. The method of any one of clauses 13-15, further comprising:
detecting, by the region prefetcher circuit, a second memory access request to a second memory block of the first contiguous memory region;
determining, by the region prefetcher circuit, that the second memory access request results in a hit on the prefetch buffer; and
responsive to determining that the second memory access request results in a hit on the prefetch buffer, fulfilling, by the region prefetcher circuit, the second memory access request using data corresponding to the second memory block from the prefetch buffer.
   17. The method of any one of clauses 13-16, further comprising:
determining, by the region prefetcher circuit, that a writeback results in a hit in the prefetch buffer; and
responsive to determining that the writeback results in a hit in the prefetch buffer:
   invalidating, by the region prefetcher circuit, a prefetch buffer entry of the prefetch buffer corresponding to the writeback; and
   forwarding, by the region prefetcher circuit, the writeback to a memory controller of the system memory device.
      18. The method of any one of clauses 12-17, wherein:
the method comprises prefetching the one or more memory blocks from one of the system memory device and a last-level cache (LLC) memory device into a cache memory device; and
detecting the prefetch trigger event comprises determining that a count of set bits of the plurality of bits of the first access bitmap exceeds a set bit threshold.
   19. The method of any one of clauses 12-18, further comprising, prior to identifying a first access bitmap, allocating, by the region prefetcher circuit, the first access bitmap for the first contiguous memory region.
   20. The method of clause 19, wherein allocating the first access bitmap comprises:
determining, by the region prefetcher circuit, that no access bitmap of the plurality of access bitmaps is available; and
allocating, by the region prefetcher circuit, an in-use access bitmap as the first access bitmap according to a Least-Recently-Used (LRU) replacement policy.

What is claimed is:

1. A processor-based device, comprising:
a region prefetcher circuit comprising a plurality of access bitmaps, each corresponding to a contiguous memory region of a plurality of contiguous memory regions of a system memory device;
wherein each access bitmap comprises a plurality of bits, each corresponding to a memory block of a plurality of memory blocks of the contiguous memory region; and
the region prefetcher circuit configured to:
detect a first memory access request to a first memory block of a first contiguous memory region of the plurality of contiguous memory regions;
identify a first access bitmap corresponding to the first contiguous memory region;
identify a first bit, corresponding to the first memory block, of the plurality of bits of the first access bitmap;
set the first bit to indicate the first memory access request to the first memory block;
detect a prefetch trigger event; and
responsive to detecting the prefetch trigger event:
identify one or more unset bits of the first access bitmap; and
prefetch one or more memory blocks, corresponding to the one or more unset bits, of the first contiguous memory region.

2. The processor-based device of claim 1, wherein:
each contiguous memory region of the plurality of contiguous memory regions comprises an open memory page of a plurality of open memory pages of the system memory device; and
the region prefetcher circuit is configured to prefetch the one or more memory blocks from the system memory device into a prefetch buffer.

3. The processor-based device of claim 2, wherein:
the region prefetcher circuit is configured to detect the prefetch trigger event by being configured to determine that the first contiguous memory region corresponding to the first access bitmap is to be closed; and
the region prefetcher circuit is further configured to clear the first access bitmap after the first contiguous memory region is closed.

4. The processor-based device of claim 2, wherein the region prefetcher circuit is configured to detect the prefetch trigger event by being configured to determine that a count of set bits of the plurality of bits of the first access bitmap exceeds a set bit threshold.

5. The processor-based device of claim 2, wherein the region prefetcher circuit is further configured to:
detect a second memory access request to a second memory block of the first contiguous memory region;
determine whether the second memory access request results in a hit on the prefetch buffer;
responsive to determining that the second memory access request results in a hit on the prefetch buffer, fulfill the second memory access request using data corresponding to the second memory block from the prefetch buffer; and
responsive to determining that the second memory access request results in a miss on the prefetch buffer, forward the second memory access request to a memory controller of the system memory device.

6. The processor-based device of claim 2, wherein the region prefetcher circuit is further configured to:
determine that a writeback results in a hit in the prefetch buffer; and
responsive to determining that the writeback results in a hit in the prefetch buffer:
invalidate a prefetch buffer entry of the prefetch buffer corresponding to the writeback; and
forward the writeback to a memory controller of the system memory device.

7. The processor-based device of claim 1, wherein:
the region prefetcher circuit is configured to prefetch the one or more memory blocks from one of the system memory device and a last-level cache (LLC) memory device into a cache memory device; and
the region prefetcher circuit is configured to detect the prefetch trigger event by being configured to determine that a count of set bits of the plurality of bits of the first access bitmap exceeds a set bit threshold.

8. The processor-based device of claim 1, wherein the region prefetcher circuit is further configured to, prior to identifying a first access bitmap, allocate the first access bitmap for the first contiguous memory region.

9. The processor-based device of claim 8, wherein the region prefetcher is configured to allocate the first access bitmap by being configured to:
determine that no access bitmap of the plurality of access bitmaps is available; and
allocate an in-use access bitmap as the first access bitmap according to a Least-Recently-Used (LRU) replacement policy.

10. The processor-based device of claim 1, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

11. A processor-based device, comprising:
means for detecting a first memory access request to a first memory block of a first contiguous memory region of a plurality of contiguous memory regions of a system memory device;
means for identifying a first access bitmap, corresponding to the first contiguous memory region, of a plurality of access bitmaps, each corresponding to a contiguous memory region of the plurality of contiguous memory regions;
means for identifying a first bit, corresponding to the first memory block, of a plurality of bits of the first access bitmap;
means for setting the first bit to indicate the first memory access request to the first memory block;
means for detecting a prefetch trigger event; and
means for, responsive to detecting the prefetch trigger event:
identifying one or more unset bits of the first access bitmap; and
prefetching one or more memory blocks, corresponding to the one or more unset bits, of the first contiguous memory region.

12. A method for performing memory region prefetching, comprising:
detecting, by a region prefetcher circuit of a processor-based device, a first memory access request to a first memory block of a first contiguous memory region of a plurality of contiguous memory regions of a system memory device;
identifying, by the region prefetcher circuit, a first access bitmap, corresponding to the first contiguous memory region, of a plurality of access bitmaps, each corresponding to a contiguous memory region of the plurality of contiguous memory regions;
identifying, by the region prefetcher circuit, a first bit, corresponding to the first memory block, of a plurality of bits of the first access bitmap;
setting, by the region prefetcher circuit, the first bit to indicate the first memory access request to the first memory block;
detecting, by the region prefetcher circuit, a prefetch trigger event; and
responsive to detecting the prefetch trigger event:
identifying, by the region prefetcher circuit, one or more unset bits of the first access bitmap; and
prefetching, by the region prefetcher circuit, one or more memory blocks, corresponding to the one or more unset bits, of the first contiguous memory region.

13. The method of claim 12, wherein:
each contiguous memory region of the plurality of contiguous memory regions comprises an open memory page of a plurality of open memory pages of the system memory device; and
the method comprises prefetching the one or more memory blocks from the system memory device into a prefetch buffer.

14. The method of claim 13, wherein:
detecting the prefetch trigger event comprises determining that the first contiguous memory region corresponding to the first access bitmap is to be closed; and
the method further comprises clearing the first access bitmap after the first contiguous memory region is closed.

15. The method of claim 13, wherein detecting the prefetch trigger event comprises determining that a count of set bits of the plurality of bits of the first access bitmap exceeds a set bit threshold.

16. The method of claim 13, further comprising:
detecting, by the region prefetcher circuit, a second memory access request to a second memory block of the first contiguous memory region;
determining, by the region prefetcher circuit, that the second memory access request results in a hit on the prefetch buffer; and
responsive to determining that the second memory access request results in a hit on the prefetch buffer, fulfilling, by the region prefetcher circuit, the second memory access request using data corresponding to the second memory block from the prefetch buffer.

17. The method of claim 13, further comprising:
determining, by the region prefetcher circuit, that a writeback results in a hit in the prefetch buffer; and
responsive to determining that the writeback results in a hit in the prefetch buffer:
invalidating, by the region prefetcher circuit, a prefetch buffer entry of the prefetch buffer corresponding to the writeback; and
forwarding, by the region prefetcher circuit, the writeback to a memory controller of the system memory device.

18. The method of claim 12, wherein:
the method comprises prefetching the one or more memory blocks from one of the system memory device and a last-level cache (LLC) memory device into a cache memory device; and
detecting the prefetch trigger event comprises determining that a count of set bits of the plurality of bits of the first access bitmap exceeds a set bit threshold.

19. The method of claim 12, further comprising, prior to identifying a first access bitmap, allocating, by the region prefetcher circuit, the first access bitmap for the first contiguous memory region.

20. The method of claim 19, wherein allocating the first access bitmap comprises:
determining, by the region prefetcher circuit, that no access bitmap of the plurality of access bitmaps is available; and
allocating, by the region prefetcher circuit, an in-use access bitmap as the first access bitmap according to a Least-Recently-Used (LRU) replacement policy.
